(19) United States
(12) Patent Application Publication
(10) Pub. No.: US 2017/0008445 A1
(43) Pub. Date: Jan. 12, 2017

(54) MOTOR VEHICLE HEADLAMP ARRANGEMENT, MOTOR VEHICLE HEADLAMP SYSTEM, MOTOR VEHICLE AND METHOD FOR OPERATING A MOTOR VEHICLE

(71) Applicant: GM GLOBAL TECHNOLOGY OPERATIONS LLC, Detroit, MI (US)

(72) Inventors: Philipp ROECKL, Ruesselsheim (DE); Lothar TESKE, Ruesselsheim (DE)

(73) Assignee: GM GLOBAL TECHNOLOGY OPERATIONS LLC, Detroit, MI (US)

(21) Appl. No.: 15/204,403

(22) Filed: Jul. 7, 2016

(30) Foreign Application Priority Data
Jul. 7, 2015 (DE) 102015008729.0

(51) Int. Cl. B60Q 1/08; B60Q 1/10

(52) U.S. Cl. CPC B60Q 1/085; B60Q 1/10; B60Q 2300/23; B60Q 2300/45

(57) ABSTRACT

A motor vehicle headlamp of a motor vehicle includes a first motor vehicle headlamp and a second motor vehicle headlamp. The first and second motor vehicle headlamp include an illuminant for a low-beam light, a high-beam light and an ambient light above a propagation direction of a light distribution of the high-beam light. The ambient light can be emitted each combined with low-beam light and/or high-beam light and is separately adjustable for each headlamp.

### CROSS-REFERENCE TO RELATED APPLICATION

This application claims priority to German Patent Application No. 102015008729.0, filed Jul. 7, 2015, which is incorporated herein by reference in its entirety.

### TECHNICAL FIELD

The present disclosure pertains to a motor vehicle headlamp arrangement, a motor vehicle and a method for operating a motor vehicle headlamp system, and more particularly a motor vehicle headlamp arrangement having a first motor vehicle headlamp and at least one second motor vehicle headlamp configured to emit a variable light distribution.

### BACKGROUND

Motor vehicle headlamp arrangements, motor vehicle headlamp systems, motor vehicles and methods for operating motor vehicle headlamp systems of the type mentioned at the outset are generally known in the art. In particular, from automotive engineering it is generally known to provide various light functions which are directed in travelling direction and between which switching-over is possible when required, for example between low-beam light and high-beam light and the like.

In addition to this it is known on the one hand to provide manually guidable headlamps, for example for aiming at signs or in the case of off-road vehicles for searching the terrain. As an example. DE 10 2005 036 002 A1 discloses a method for controlling a lighting device of a vehicle conducted by an operating person, which detects a viewing direction of the operating person to the road located in front of the same. As a function of the detected information via the viewing direction at least one parameter of at least one settable and adjustable headlamp of the lighting device is set. Furthermore, a corresponding headlamp system is described.

Viewing direction-controlled systems can emit unsettled light distributions following the rapid viewing direction changes. The continuously changing light distributions resulting from this can irritate and negative affect the driving safety. In addition, for example when reading a traffic sign that is usually mounted relative high up, a region can be swept with the light when looking up, in which oncoming traffic can be dazzled, so that the traffic safety of other road users is negatively affected by this.

### SUMMARY

In accordance with the present disclosure, a motor vehicle headlamp arrangement, a motor vehicle headlamp system, a motor vehicle and a method for operating a motor vehicle headlamp system is provided that adapts lighting without dazzling the oncoming traffic. According to a first aspect, the motor vehicle headlamp arrangement includes at least one first motor vehicle headlamp and at least one second motor vehicle headlamp. The first motor vehicle headlamp and the second motor vehicle headlamp each include at least one illuminant for a low-beam light, a high-beam light and an ambient light. The ambient light in each case is designed for emitting light with a propagation direction of the light distribution of the ambient light above a propagation direction of a light distribution of the high-beam light. The ambient light can each be emitted combined with low-beam light and/or high-beam light and is settable separately for each headlamp. The same or different illuminants can be used for low-beam light and high-beam light.

An ambient light in the sense mentioned here is lighting that is directed upwards, the propagation direction of which is located above the propagation direction of the high-beam light. The propagation direction in this case is the mean propagation direction of the respective light, that is the ambient light or of the high-beam light, Thus, the ambient light illuminates a region in which information that is relevant to the driver of a motor vehicle is arranged, for example on traffic signs. The ambient light can be configured in such a manner that it does not dazzle the oncoming traffic.

In addition, the ambient light can be emitted combined with low-beam light and/or high-beam light. Thus, the regular lighting can be maintained and complemented by the ambient light. The ambient light generally forms an illuminated zone that is separate from a low-beam light and in some configurations also from a high-beam light. In other configurations, the ambient light can expand the high-beam light upwards. Through the separate settability for each motor vehicle headlamp. the ambient light can be directed at a region that is of interest to the driver, for example to a traffic sign.

A further aspect provides that a lower limit of the ambient light, re. a lower limit of the illuminated region of the ambient light is inclined towards the top with an angle of inclination of 2.5° and greater relative to a road plane. Alternatively, the ambient light, based on a lower limit of the illuminated region, can lie in an angle of inclination range of 4° relative to the road plane upwards and greater, in particular 5° and greater based on a lower limit of the illuminated region. Thus, the oncoming traffic is not dazzled at usual distances for example 25 m or greater. The information relates to a headlamp that is properly installed in a motor vehicle. The lower of the illuminated region can in some configurations have even greater angles of inclination relative to the road plane. In the case of roads which are not level the road plane is defined by the contact patches of the tires on the road. In some configurations of the headlamp arrangement, the angle of inclination of the ambient light can be variable, in order to prevent that oncoming traffic is dazzled by the ambient light.

Laterally, the ambient light can be delimited in such a manner that the oncoming traffic, which falls below a certain distance to the own motor vehicle, lies outside the ambient light. Another further aspect of the motor vehicle headlamp arrangement provides that the ambient light is laterally settable, as a result of which each motor vehicle headlamp can be laterally set separately. Because of this, traffic signs which are also arranged on the shoulder of the road can be illuminated by means of the ambient light.

In another configuration, the ambient light of the first motor vehicle headlamp can shine in a direction other than the ambient light of the second motor vehicle headlamp. Furthermore, it can be made possible to illuminate to traffic signs simultaneously, for example a sign bridge and a traffic sign which is arranged on a post on the side.

A further aspect of the motor vehicle headlamp arrangement provides at least one optical element in at least one of the motor vehicle headlamps, which is arranged in the optical path downstream of an illuminant. The optical element can be adjustable in order to vary the ambient light, in particular to activate and deactivate the same and/or in order to set the angular range of the same relative to the road plane. The optical element can be adjustable in particular bi-axially.

According to a configuration, the optical element can he designed in order to activate the ambient light in that the optical element opens the optical path for the ambient light. Alternatively, or additionally, the optical element can form the ambient light, i.e. define limits of the ambient light. The optical element can additionally or alternatively set the ambient light, for example change the position of the ambient light. This change in position of the ambient light can be controlled dependent on the viewing direction.

In a further configuration of the motor vehicle headlamp arrangement, the optical element can include a diaphragm. Such a diaphragm can among others be a modular diaphragm, a shutter diaphragm or a slit diaphragm. With the help of a diaphragm, regions of the ambient light can be defined. In particular slit diaphragms make possible defining a spatially limited ambient light.

According to a further aspect of the motor vehicle headlamp arrangement, the optical element can be arranged between the illuminant and a lens of the motor vehicle headlamp. In configurations, in which the motor vehicle headlamp includes a reflector between illuminant and lens, the optical element can be arranged between reflector and lens. Such an arrangement of the optical element can be carried out in a relatively well-encapsulated region of the motor vehicle headlamp, which ensures durable functioning.

Another further aspect of the motor vehicle headlamp arrangement provides that the motor vehicle headlamps are designed for blanking-out part regions from the light distribution. In this way, an oncoming vehicle can for example be excluded from the light distribution no as not to dazzle the same. By activating the ambient light located high up it can nevertheless be achieved that traffic signs, which are above the oncoming motor vehicle, for example can be illuminated with the ambient light. Such blanking-out of the oncoming traffic from the light distribution then no longer impairs the readability of traffic signs. In a high-beam mode, the ambient light can merge with the regular lighting and expand the high-beam light distribution towards the top.

According to another aspect of the motor vehicle headlamp arrangement, the motor vehicle headlamps can each include at least one matrix headlamp. The motor vehicle headlamps can be designed as matrix headlamps or include another headlamp in addition to the matrix headlamp. Matrix headlamps are headlamps which include a plurality of individual light elements, which can be variably switched on. Switching-on can relate to groups or individual light elements. With the help of matrix headlamps, a variable light distribution can he stated without having to depend on ajustable, i.e. for example pivotable headlamps. Matrix headlamps can be combined in particular with optical elements in order to activate an ambient light. Matrix headlamps are frequently employed for variable high-beam light distributions.

Another further aspect of the motor vehicle headlamp arrangement provides that for the ambient light at least one additional headlamp is provided. The addition headlamp can be suitably oriented in order to spotlight the corresponding angular range of 2.5° or greater towards the top with respect to a. road plane based on the lower limit of the illuminated region.

According to another further aspect, the motor vehicle headlamp arrangement is equipped in order to activate the ambient light in a low-beam light mode. Accordingly, a corresponding ambient light can also be stated when because of the traffic conditions no high-beam light is activatable. Since low-beam light is predominantly directed downwards a correspondingly oriented ambient light is particularly helpful since regions above the stated angular range are relatively poorly illuminated or not at all.

Another aspect of the motor vehicle headlamp arrangement provides that the ambient light is created through the partial defocusing of a light beam. By defocusing, the contrast boundaries can be softened which is more pleasant for the eye in the region of the ambient light.

According to another further aspect, a camera facing in travelling direction is provided for detecting traffic signs. The camera is connected to a control of the motor vehicle headlamp arrangement. The control is equipped in order to direct the ambient light onto at least one traffic sign detected by the camera Because of this, illumination of the traffic sign with the ambient light can be made possible.

In configurations, in which the ambient light is laterally orientable, the traffic sign can be a traffic sign that is arranged on the shoulder of the road.

In a further configuration, a driver monitoring device for detecting a viewing direction of a driver can be provided. With the help of the driver monitoring device, the region in which or where a driver is looking can thus be determined. Furthermore, the control is connected to the driver monitoring device. The control is equipped in order to activate the ambient light when a viewing direction of the driver lies in an angular range of +2° or greater upwards relative to a road plane.

Because of the fact that the ambient light can be activated when the driver correspondingly looks up for example in order to detect a traffic sign, the illumination of regions that are located relatively high up can be improved so that detecting information in such regions that are located higher up is simplified. By activating the ambient light an unsettled illumination image can be additionally avoided, which possibly has an irritating effect.

According to another further aspect it can be provided that the viewing direction of the driver lies in an angular range of 1.5° or greater. Usually, the motor vehicle headlamps are arranged lower than eyes of the driver, so that in the relevant distances an overlap of viewing direction and ambient light is present.

The motor vehicle headlamp arrangement can, furthermore, be equipped according to a configuration in such a manner that the angular difference between viewing direction and lighting direction resulting from the different positions is automatically compensated.

Another further aspect of the motor vehicle headlamp arrangement provides for detecting oncoming motor vehicles with a camera. The control is equipped in order to blank out the part region, in which the oncoming motor vehicle is located, from the light distribution. With the help of the camera, oncoming motor vehicles can be reliably identified with the help of suitable detection algorithms. Additionally or alternatively to a camera, other systems, for example radar or lidar can be used. The detection of the motor vehicles can be implemented in the camera or in the control.

A further aspect of the motor vehicle headlamp arrangement provides that the control is designed in order to actuate the optical element as a function of the viewing direction of the driver. As a consequence, the ambient light can be activated among other things. A first independent subject relates to a motor vehicle headlamp system. The motor vehicle headlamp system includes a motor vehicle headlamp arrangement of the aforementioned type, which is designed for emitting a. variable light distribution. The motor vehicle headlamp arrangement is designed in order to emit an ambient light towards the top relative to a road plane.

The ambient light is designed so that the oncoming traffic is not dazzled, The angle of inclination relative to the road plane can be 2.5° and greater, in particular 4° and greater, in particular 5° and greater towards the top, based on the lower limit of the illuminated region. The lower limit of the illuminated region can in some configurations have even greater angles of inclination relative to the road plane. In such angular ranges, illumination of a traffic sign can be achieved on the one hand while dazzling of the oncoming traffic at usual distances can be avoided on the other hand. Depending on the remaining setting of the headlamp, the ambient light can be a light region that is separate from the remaining light distribution.

Furthermore, a camera facing in travelling direction is provided for detecting traffic signs. The camera is connected to a control of the motor vehicle headlamp arrangement. The control is equipped in order to direct the ambient light onto at least one traffic sign detected by the camera. Thus, illumination of the traffic sign with the ambient light can be made possible.

In configurations in which the ambient light can be laterally oriented, the traffic sign can be a traffic sign that is arranged on the shoulder of the road. In a first further configuration, a driver monitoring device for detecting a viewing direction of a driver can be provided. With the help of the driver monitoring device, the region in which or where a driver is looking can thus he determined. Furthermore, the control is connected to the driver monitoring device, The control is equipped in order to activate the ambient light when a viewing direction of the driver is in an angular range of +2° or greater upwards relative to a road plane.

Because of the fact that the ambient light can be activated when the driver, accordingly, looks up for example in order to detect a traffic sign, the illumination of regions which are located relatively high up can be improved so that detecting information in such regions located higher up is simplified. By activating the ambient light an unsettled illumination image can be additionally avoided, which possibly has an irritating effect.

According to another further aspect it can be provided that the viewing direction of the driver lies in an angular range of 1.5° or greater. Usually, the motor vehicle headlamps are arranged lower than eyes of the driver, so that in the relevant distances an overlap of viewing direction and ambient light is present.

The motor vehicle headlamp system can, furthermore, be equipped according to a configuration in such a manner that the angular difference between viewing direction and lighting direction resulting from the different positions is automatically compensated.

Another further aspect of the motor vehicle headlamp system provides that oncoming motor vehicles are detectable with a camera. The control is equipped in order to blank out the part region, in which the oncoming motor vehicle is located, from the light distribution. With the help of the camera, oncoming motor vehicles can be reliably identified with the help of suitable detection algorithms. Additionally or alternatively to a camera, other systems, for example radar or lidar can be used. The detection of the motor vehicles can be implemented in the camera or in the control.

A further aspect of the motor vehicle headlamp system provides that the control is designed in order to actuate the optical element as a function of the viewing direction of the driver. As a consequence, the ambient light can be activated among other things.

A further independent subject described here relates to a method for operating a motor vehicle headlamp system. According to a first aspect, the motor vehicle headlamp system is designed for emitting a variable light distribution. A motor vehicle headlamp arrangement of the motor vehicle headlamp system is designed in order to emit an ambient light, based on the lower limit of the illuminated region, in an angular rang of 2.5° or greater towards the top and to at least one side obliquely upwards relative to a road plane. Such ambient light can help to improve the detectability and readability of traffic signs.

Furthermore, a traffic sign located in front of the motor vehicle is detected with a camera. The ambient light is activated by a control when the traffic sign is located outside an active illumination by way of the low-beam light or high-beam light.

The motor vehicle headlamp system can correspond in particular to the motor vehicle headlamp system described previously.

A first configuration of the method can provide that with a driver monitoring device a viewing direction of a driver is detected, wherein the ambient light of the motor vehicle headlamp system is activated by a control when a viewing direction of the driver lies in an angular range of 2° or greater relative to the road plane. Thus, activation of the ambient light can take place dependent on the viewing direction.

Another configuration of the method can provide that a moveable optical element in the motor vehicle headlamps of the motor vehicle headlamp system is actuated in such a manner that the ambient light falls in the viewing direction of the driver. The moveable optical element can be driven by an actuator, in particular an electrical actuator. The optical element in this case can serve for activating or deactivating the ambient light of the headlamp. Additionally or alternatively it can serve for adapting the ambient light if the ambient light is to be adjustable.

According to a further aspect of the method, the motor vehicle headlamps can exclude a part region from the illumintion. Thus, dazzling of the oncoming traffic can be avoided. In particular, the motor vehicle headlamps can exclude a part region from the normal illumination, for example a low-beam light or a high-beam light.

A further aspect of the method may provide that the ambient light is activated when the part region, which is excluded from the illumination, lies in a viewing range of the driver. In this case, a shadow can otherwise lie above the blanked-out region which worsens the readability of traffic signs in this region. By activating the ambient light such a contrast situation can be avoided while dazzling of oncoming motor vehicles is nevertheless omitted.

A further aspect of the method provides that the motor vehicle headlamp system otherwise emits a low-beam light. In this way, two light regions that are separated from one another are defined by the low-beam light and by the ambient light, which avoid dazzling the oncoming traffic yet make possible the readability of traffic signs located high up.

A further independent aspect relates to a device for operating a motor vehicle headlamp system which is designed for emitting a variable light distribution. The motor vehicle headlamp system emits an ambient light in an angular range of 2.5° or greater towards the top and at least to one side obliquely towards the top relative to a road plane.

Furthermore, a camera is provided with which a traffic sign located in front of the motor vehicle can be detected. The ambient light is activatable by a control when the traffic sign is located outside an active illumination by way of low-beam light or high-beam light.

According to a first further aspect of the device, a driver monitoring device can be provided which is equipped in order to detect a viewing direction of a driver. The control, which in this configuration is connected to the driver monitoring device, activates the ambient light can be actuated, The control is equipped in order to actuate the means when a viewing direction of the driver lies in an angular range of 2.5° or greater relative to a road plane.

According to a first further aspect of the present disclosure a moveable optical element can be provided in a motor vehicle headlamp of the motor vehicle headlamp system which is actuatable in such a manner that the ambient light of the headlamp is activatable andior falls into the viewing direction of the driver.

According to a further aspect of the device, the motor vehicle headlamp may exclude a part region from the illumination.

According to a further aspect of the present disclosure it can be provided that the control is equipped in order to activate the ambient light when the part region lies in a viewing range of the driver.

A further aspect of the device provides that the motor vehicle headlamp arrangement is designed in order to otherwise emit a low-beam light.

### BRIEF DESCRIPTION OF THE DRAWINGS

The present disclosure will hereinafter be described in conjunction with the following drawing figures, wherein like numerals denote like elements.

FIG. 1 is a top view of a motor vehicle;

FIG. 2 is a view from a cockpit of the motor vehicle from FIG. 1;

Fig. .3 shows the view from FIG. 2 with an oncoming motor vehicle;

FIG. 4 shows the view from FIG. 3 on viewing a sign bridge;

FIG. 5 is a schematic representation of a headlamp arrangement according to a first embodiment;

FIG. 6 is a schematic representation of a headlamp arrangement according to a second embodiment;

FIG. 7 is a schematic representation of a headlamp arrangement according to a third embodiment; and

FIG. 8 is a lateral view of the motor vehicle with a description of the different illumination zones.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

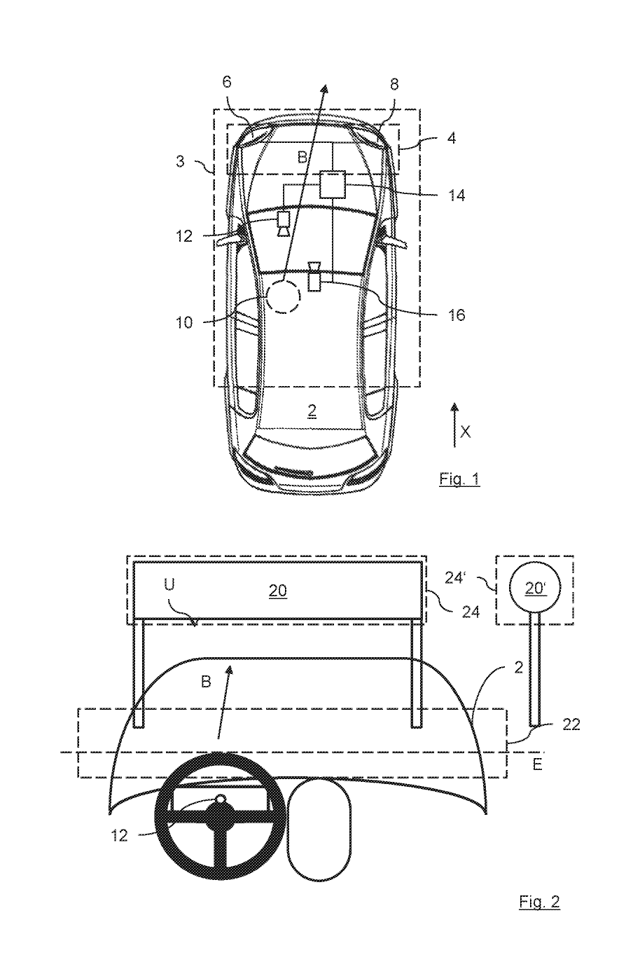

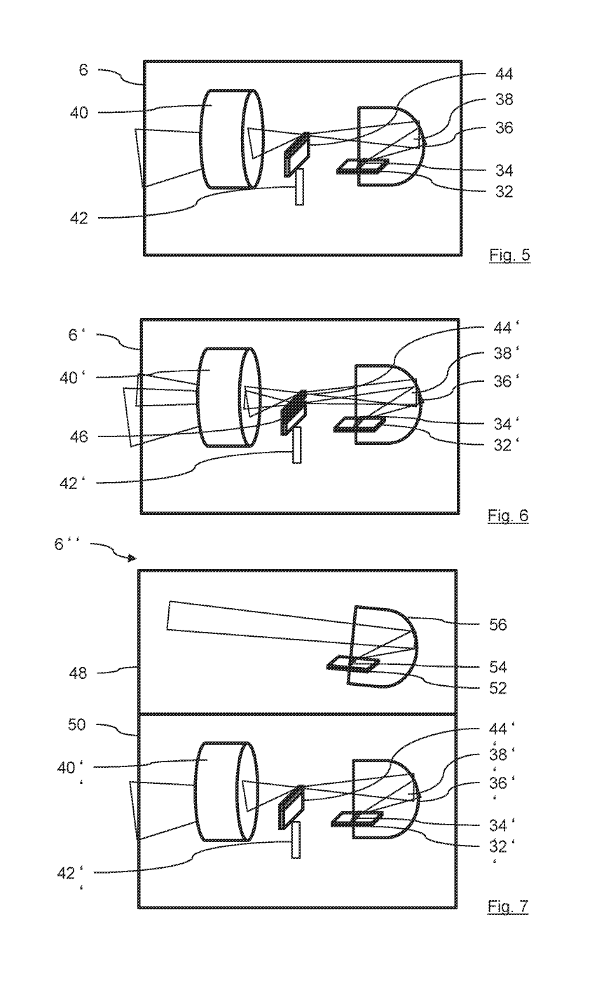

FIG. 1 shows a top view of a motor vehicle 2. The motor vehicle 2 includes a motor vehicle headlamp system 3 (framed in dashed line). The motor vehicle headlamp system 3 includes a motor vehicle headlamp arrangement 4 with headlamps 6, 8. The headlamps 6, 8 illuminate a region located in travelling direction X in front of the motor vehicle 2. The headlamps 6, 8 are designed as matrix headlamps, which make possible a variable light distribution. Details of the possible configurations of the headlamps 6, 8 are shown in FIGS. 5 to 7.

The motor vehicle 2 is driven by a driver 10 (shown in dashed line). The driver 10 looks in aviewing direction B. The viewing direction B on the one hand has an angle relative to the travelling direction X, on the other hand an angle relative to the road plane E (see FIG. 5ff.). Accordingly, the driver 10 can look in different directions, straight ahead, to the left or right and simultaneously up, down or straight ahead. The viewing direction B of the driver 10 is detected with the help of a driver monitoring camera 12 which is directed at the driver 10. The driver monitoring camera 12 can for example detect the eyes of the driver 10 and from their position estimate the viewing direction B of the driver 10. Such a driver monitoring camera 12 can be arranged for example in an instrument panel of the motor vehicle 2.

Driver monitoring camera 12 and the headlamps 6, 8 are connected to a control 14. The control 14 is able to control the headlamps 6, 8 as a function of the input signals of the driver monitoring camera 12. and thus of the viewing direction B of the driver. When the driver 10 looks up in an angular range of 2.5° or greater relative to a road plane E, the control 14 activates the headlamps 6, 8 in such a manner that an ambient light is activated which facilitates detection and possibly reading of information in an upper field of vision without dazzling the oncoming traffic.

Furthermore, a front camera 16 is provided, which is oriented in travelling direction X. The front camera 16 is likewise connected to the control 14. With the help of the front camera 16, traffic signs and oncoming traffic can be detected and the illumination of the headlamps 6, 8 adapted by changing the activation of the matrix elements of the headlamps 6, 8.

The control 14 is able to control the headlamps 6, 8 as a function of the input signals of the front camera 16. When the front camera 16 detects a laterally arranged traffic sign or a sign bridge, the ambient light can be activated so that traffic signs and/or sign bridge can be illuminated.

FIG. 2 shows a cockpit view of the motor vehicle 2. The motor vehicle 2 travels towards a sign bridge 20. The sign bridge 20 lies above a low-beam light range 22 and is normally not illuminated. The sign bridge 20 is therefore difficult to read with conventional lighting systems in the low-beam light mode since the same is not directly illuminated.

By equipping the motor vehicle 2 with a suitable motor vehicle headlamp system 3, an ambient light 24 can be activated which illuminates the region of the sign bridge 20. The ambient light 24 is a region that is separate from the low-beam light range 22 and lies above a zone in which oncoming motor vehicles can be dazzled. This region usually lies aboveb 2.5°, in particular 4°, in particular 5° relative to the road plane E, based on a lower limit U of the illuminated region.

In addition, an ambient light 24′ can be activated by the control 14 in order to illuminate the laterally arranged traffic sign 20′. To this end, the headlamps 6, 8 can be separately activated so that the ambient light 24 actually falls on the traffic sign 20′. In particular, the control 14 can take into account the changing relative position of the traffic sign 20′ with the motor vehicle 2 moving towards the traffic sign 20′ and dynamically adapt the headlamps 6, 8.

Whether the ambient lights 24 or 24′ are activated can be made a function of the viewing direction B of the driver 10. When said driver looks at the sign bridge 20, the ambient light 24 is activated, when he looks at the traffic sign 20′, the ambient light 24′ is activated.

Alternatively, a headlamp can take over an ambient light and the other headlamp the other. In the present case, the headlamp 6 can illuminate the sign bridge 20 and the right headlamp 8 the right traffic sign 20′ that is arranged next to the road.

FIG. 3 shows an illumination situation with an oncoming motor vehicle 26. The headlamps 6, 8 are operated in a high-beam light mode in which a high-beam light region 28 is illuminated. The viewing direction B of the driver 10 falls into the high-beam light region 28. From the high-beam light region 28 a part region 30 is excluded, in which the motor vehicle 26 is located. In this way, dazzling of the oncoming vehicle 26 is prevented.

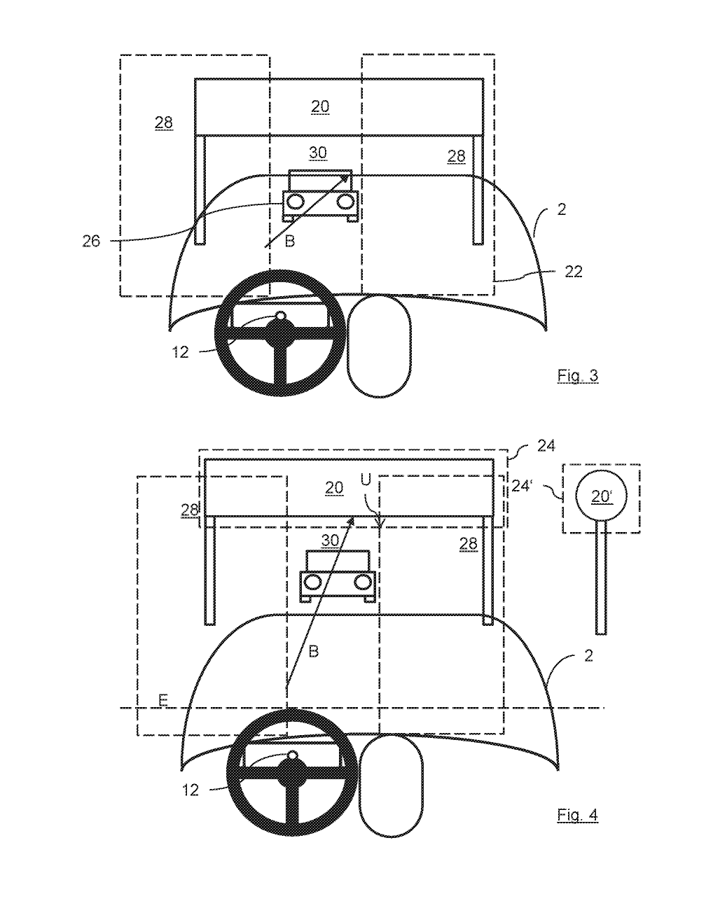

FIG. 4 shows the view from FIG. 3, wherein the viewing direction B points upwards in the direction of the sign bridge 20 by more than 2.5° relative to the road plane E. The viewing direction B is detected by the driving monitoring camera 12 and the ambient light 24 activated. The illumination created because of this allows the exclusion of the part region 30 about the motor vehicle 26, but simultaneously good readability of the sign bridge 20 by way of the ambient light 24 falling on it. If the driver 10 were to look at the traffic sign 20′, the ambient light 24′ could be activated.

FIG. 5 shows a first possible embodiment of the headlamp 6. The headlamp 6 includes an LED circuit board 32 with a plurality of LEDs 34. The LEDs 34 can be individually accessed in order to generate different light distributions, namely low-beam light 22, high-beam light 28 and the previously described ambient light 24. The headlamp 6 is designed in order to exclude part regions from the light distribution so as not to dazzle for example oncoming traffic in a high-beam light mode, Ambient light 24 and low-beam light 22 or high-beam light 28 can be activated together. The LEDs 34 shine onto a reflector 36, from where a light beam 38 falls on a lens 40, which shapes the light beam 38.

Between reflector 36 and lens 40, a diaphragm 44 that is adjustable by a motor 42 is provided, which can be brought into the optical path and which can suitably reshape the light beam 38 in order to generate the ambient light 24.

FIG. 6 shows a second embodiment of a headlamp 6′. The headlamp 6′ can likewise generate low-beam light 22, high-beam light 28 and an ambient light 24. The headlamp 6′ includes a diaphragm 44′ with a slit 46. The diaphragm 44′ is laterally offset so that light falls past the diaphragm 44′. This light forms the normal low-beam light. Light that falls through the slit 46 of the diaphragm 44′ is shaped by the slit 44′ in such a manner that the ambient light 24 is shaped accordingly. The diaphragm 44 is motor-adjustable and/or activatable through activation of the matrix light elements,

FIG. 7 shows a further embodiment of a headlamp 6″. The headlamp 6″ can also generate low-beam light 22, high-beam light 28 and an ambient light 24. The headlamp 6″ includes two separate headlamp parts 48, 50, of which the headlamp part 48 is designed for generating the ambient light 24. The headlamp part 48 includes an LED circuit board 52 with LEDs 54, the light from a reflector 56 of Which can be reflected in travelling direction X in an angular range of greater than 5° relative to a road plane E.

The headlamp part 50 includes an LED circuit board 32″ with a plurality of LEDs 34″. The LEDs 34″ can be individually accessed in order to generate different light distributions. The LEDs 34″ shine onto a. reflector 36″, from where a light beam 38″ falls onto a lens 40″, which shapes the light beam 38″. Between reflector 36″ and lens 40″, a diaphragm 44 that is adjustable by means of a motor 42″ is provided, which can be brought into the optical path and which can reshape the light beam 38″ accordingly.

In all embodiments according to FIGS. 5 to 7, the optical configuration can be such that the ambient light 24, 24′ is defocused, e.g. through a suitable configuration of lenses. Furthermore, diffusion lenses can be provided in order to render the ambient light 24, 24′ softer in illumination strength and with respect to the contrast profiles.

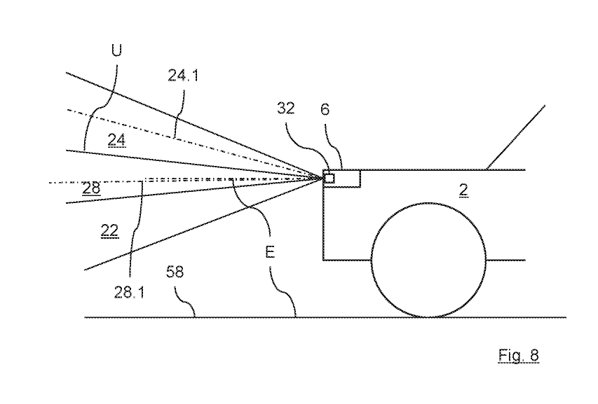

FIG. 8 shows a lateral view of the motor vehicle 2 with a description of the different illumination zones. The motor vehicle 2 stands on a road 58, which defines a road plane E. The road plane E is a reference to the adjustment of the headlamp 6. The low-beam light range 22 is slightly inclined downwards relative to the road plane E, The high-beam light range 28 follows the low-beam light range 22, The high-beam light range 28 can also overlap with the low-beam light range 22. An upper limit of the high-beam light range 28 usually lies inclined in an angular range of 2.5° upwards relative to the road plane E.

The ambient light 24 covers an even higher range which is selected so that it does not dazzle oncoming traffic. A propagation direction 24.1 of the ambient light 24 lies above a propagation direction 28.1 of the high-beam light 28. A lower limit U of the ambient light 24 is at 2.5° in the shown embodiment. The lower limit U can also be higher in some configurations, in particular at 4° or 5°. Thus, illumination of traffic signs and the like becomes possible at relevant distances. In some configurations, the lower limit U can be variable.

Ambient light 24 and low-beam light 20 and/or high-beam light 28 are combinable so that the ambient light 24 can be combined with the low-beam light 22, with the high-beam light 28 or with low-beam light 22 and high-beam light 28. In a combination of ambient light 24 and low-beam light 22, two separate light zones are created, high-beam light 28 and ambient light 24 can be form a common light zone or likewise two separate light zones.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a. convenient road map for implementing an exemplary embodiment, it being understood that various changes may be made in the function and arrangement of elements described in an exemplary embodiment without departing from the scope of the invention as set forth in the appended claims and their legal equivalents.

1-15. (canceled)

16. A motor vehicle headlamp arrangement of a motor vehicle comprising:
a first headlamp having a first illuminant for emitting a low-beam light, a high-beam light and an ambient light;
a second headlamp having a second illuminant for emitting a low-beam light, a high-beam light and an ambient light;
wherein each of the first and second headlamp is configured to emit ambient light having a propagation direction of light distribution above a propagation direction of light distribution of the high-beam light;
wherein the ambient light from each of the first and second headlamps is combined and emitted with at least one of the low-beam light or the high-beam light; and
wherein the ambient light is separately adjustable for each of the first and second headlamps.

17. The motor vehicle headlamp arrangement according to claim 16, wherein a lower limit for the propagation direction of the ambient light is inclined upwards with an angle of inclination of at least 2.5 relative to a road plane.

18. The motor vehicle headlamp arrangement according to claim 16, wherein the ambient light for each of the first and second headlamp is laterally adjustable separately.

19. The motor vehicle headlamp arrangement according to claim 16, wherein the propagation direction of the ambient light from the first headlamp is configured to shine into a direction that is different than the propagation direction of the ambient light from the second headlamp.

20. The motor vehicle headlamp arrangement according to claim 16, wherein the first and second headlamps are configured to blank out a region from the light distribution.

21. The motor vehicle headlamp arrangement according to claim 16, wherein the first and second headlamps each comprises at least one matrix headlamp.

22. The motor vehicle headlamp arrangement according to claim 16, wherein for the ambient light wises at least a partial defocusing of a light beam.

23. The motor vehicle headlamp arrangement according to claim 16, further comprising a detector configured to detect traffic signs in a travelling direction and a control in communication with the detector and operably with at least one of the first and second headlamps to direct ambient light onto at least one traffic sign detected by the detector.

24. The motor vehicle headlamp arrangement according claim 16, further comprising a detector for determining a location of an oncoming vehicle and a control in communication with the detector and configured to blank out a partial region of the light distribution corresponding to the location of the oncoming motor vehicle.

25. The motor vehicle headlamp arrangement according to claim 16, further comprising a detector configured to determine a viewing direction of a driver, an optical element associated with at least one of the first and second headlamps and a control configured to actuate the optical element as a function of the viewing direction of the driver.

26. A motor vehicle with a motor vehicle headlamp arrangement according to claim 16.

27. A method for operating a motor vehicle headlamp system for emitting a variable light distribution comprising:
providing a headlight arrangement for emitting a low-beam light, a high-bean light and an ambient light upwardly from a road plane and obliquely to at least one side;
detecting a traffic sign a camera; and
activating the headlight arrangement with a control to emit the ambient light when the traffic sign lies outside an active illumination of the low-beam light or the high-beam light.

28. The method according to claim 27, further comprising detecting a viewing direction of a driver with a driver monitoring device and activating the ambient light when the viewing direction lies in an angular range of at least 2 towards the top relative to the road plane.

29. The method according to claim 27, further comprising blanking out a part region from the illumination of the headlamp arrangement.

30. The method according to claim 29, further comprising activating the ambient light when the part region lies in a range of vision of the driver.
